(19) United States
(12) Patent Application Publication
(10) Pub. No.: US 2013/0042793 A1
(43) Pub. Date: Feb. 21, 2013

(54) ASPHALT MODIFICATION PROCESSING SYSTEM AND METHOD FOR ASPHALT ADDITIVES

(71) Applicants: Christian Peregrine, Indianapolis, IN (US); Adam Redman, Mooresville, IN (US); Xishun Zhang, Carmel, IN (US); Anthony J. Kriech, Indianapolis, IN (US)

(72) Inventors: Christian Peregrine, Indianapolis, IN (US); Adam Redman, Mooresville, IN (US); Xishun Zhang, Carmel, IN (US); Anthony J. Kriech, Indianapolis, IN (US)

(21) Appl. No.: 13/586,339

(22) Filed: Aug. 15, 2012

Related U.S. Application Data
(60) Provisional application No. 61/524,584, filed on Aug. 17, 2011.

(51) Int. Cl. C09D 195/00; C09D 121/00; B02C 19/00; C08K 5/01

(52) U.S. Cl. 106/668; 524/59; 241/23

(57) ABSTRACT

A process method for producing modified asphalt binder compositions that involves mixing an asphalt binder and at least one asphalt additive and/or asphalt modifier in a stirred ball mill so as to subject the mixture to mixing, shearing, impacting and grinding.

### RELATED APPLICATION

The present application is based upon U.S. Provisional Application Ser. No. 61/524,584, filed Aug. 17, 2011, to which priority is claimed under 35 U.S.C. §120 and of which the entire disclosure is hereby expressly incorporated by reference.

### BACKGROUND

The present invention relates generally to asphalt products, including modified asphalt compositions. More particularly the present invention relates to methods and apparatuses for forming modified asphalt compositions, including mixing systems and process methods for creating performance enhanced asphalt compositions used in asphalt products.

Asphalt paving compositions are traditionally manufactured using asphalt cement which is derived from crude oil. Recently the prices of asphalt and crude oil have increased rapidly. In addition to the increased prices of these basic components there has also been a considerable increase in the manufacturing costs involved with combining additives with asphalt binders due to the costs of the additives and the time and energy required to add these additives to the asphalt binders.

The use of asphalt binder in paving compositions must meet performance criteria and specifications in order to be considered useful for paving applications. Conventional asphalt compositions are generally unable to meet all of the performance criteria and specifications. Failure to meet such performance criteria and specifications can result in pavements that are too soft in high temperatures, and too brittle in cold temperatures.

Conventional asphalt binders are considered neat binders and do not contain additives. Modified asphalt binders can contain a variety of additives including, polymers, crumb rubber, gilsonite, shale, shingles, and other modifiers. These additives are added at either an asphalt manufacturing terminal or a hot mix asphalt plant, and they currently all have their own unique processes of addition.

U.S. Pat. No. 4,145,322 to Maldonado et al. discloses a process for preparing bitumen-polymer compositions containing block copolymers comprising diene and styrene groups having excellent mechanical properties even at low temperatures.

U.S. Pat. No. 6,972,047 to Butler et al. discloses a method for improving asphalt compositions which involves adding to an asphalt a synthetic flux oil that includes at least one asphaltite, and a carrier oil comprising either a naphthenic or paraffinic hydrocarbon oil.

U.S. Patent Application Publication No. 2011/0049275 to Zickell et al. discloses a method of recycling asphalt shingle material which involves cryogenically milling the asphalt shingle material into a fine powder or material incorporated into asphalt. An attritor is used to break down the materials.

U.S. Patent Application Publication No. 2010/0129667 to Kalkanoglu et al. discloses roofing products that are made from recycled roofing materials. The recycled roofing materials can be processed in an attritor or other media mixer to reduce the size of roofing granules and thereby avoid poor tear strengths in the roofing products.

### BRIEF SUMMARY

According to various features, characteristics and embodiments of the present invention which will become apparent as the description thereof proceeds, the present invention provides a method for producing a modified asphalt binder composition which involves:
providing a stirred ball mill;
adding an asphalt binder into the stirred ball mill, said asphalt binder comprising virgin asphalt;
adding at least one asphalt additive into the stirred ball mill;
adding a mass of grinding media into the stirred ball mill;
mixing the asphalt binder, the least one asphalt additive and grinder media in the stirred ball mill under heating conditions to cause mixing, shearing, impacting and grinding of the mixture; and
recovering a modified asphalt composition that has improved performance characteristics as compared to a similar mixture of asphalt and additive processed in other than a stirred ball mill.

The present invention further provides a modified asphalt binder composition produced by the process method and a paving composition which includes the modified asphalt composition and aggregate material.

### BRIEF DESCRIPTION OF THE DRAWINGS

The present invention will be described with reference to the attached drawings which are given as non-limiting examples only, in which:

FIG. 1 is a schematic diagram of an attritor which depicts a process of producing modified asphalt compositions according to one embodiment of the present invention.

### DETAILED DESCRIPTION OF THE DRAWINGS AND THE PRESENTLY PREFERRED EMBODIMENTS

The present invention is directed to methods and apparatuses for forming modified asphalt compositions, including a mixing system and process method for creating performance enhanced asphalt compositions used in asphalt products.

The present invention further provides an asphalt additive mixing system and process method for forming a modified asphalt binder composition.

The process method is capable of blending asphalt additives, such as shale additive, roofing shingles, Gilsonite, recycled asphalt pavement, or other solvent soluble materials with virgin asphalt. The present invention provides modified asphalt binders that are useful for asphalt paving and other applications. The method for processing the asphalt and additive together unexpectedly results in enhanced high temperature performance characteristics in the resulting asphalt binder.

The processing method of the present invention involves subjecting the asphalt and additives to a combination of mixing, shearing, impacting and grinding.

The mixing, shearing, impacting and grinding of the asphalt and additives is performed with a grinding mill containing internally agitated grinding media; these units are commonly referred to as stirred ball mills. An attritor is an example of such a device; an attritor consists of a vessel, grinding media, and a mixing arm. When the mixing arm is rotated at high rpms it vortexes the media creating shearing and impact forces on the material inside the vessel. U.S. Pat. No. 5,464,163 to Zoz and U.S. Pat. No. 3,458,144 to Lessells et al. exemplify conventional attritors. Any type of ball mill can be used according to the present invention including, but not limited to, ball mills that are horizontal or vertical and those in which the outer walls and/or inner shafts rotate (or one is stationary).

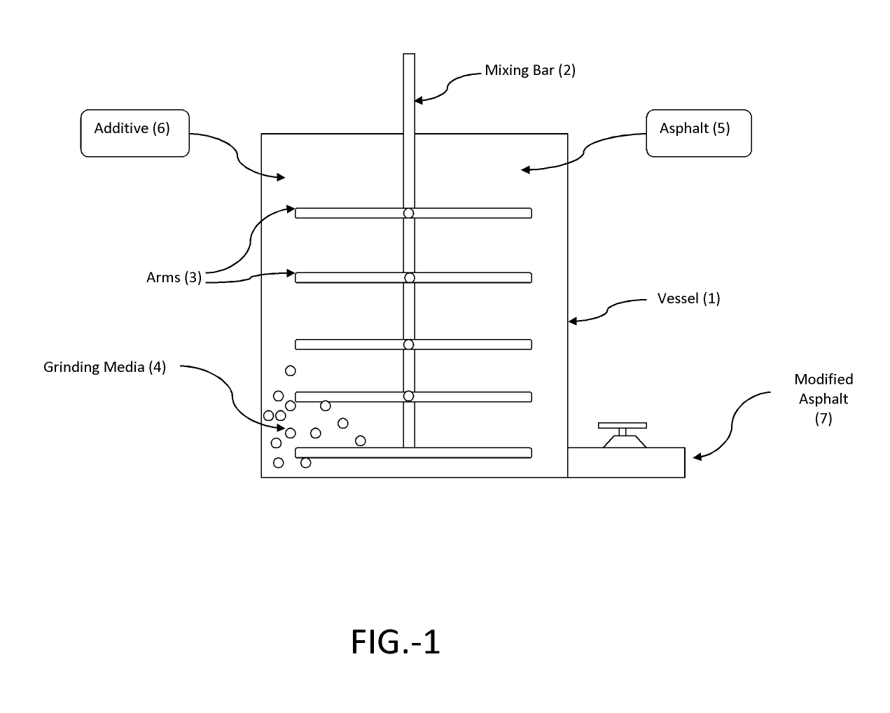

FIG. 1 is a schematic diagram of an attritor which depicts a process of producing a modified asphalt composition according to one embodiment of the present invention.

The attritor shown in FIG. 1 includes a vessel 1 which has a heating jacket or other means to heat the contents of the vessel 1 and a mixing bar 2 which extends into the vessel which, as depicted includes a plurality of arms 3 which extend outward from a central rotatable shaft of the mixing bar 2.

Reference numeral 4 identifies grinding media that is provided in vessel 1 and, for purposes of the present invention is preheated together with the mixing bar 2 and walls of the vessel 1 at least to a temperature at or above the softening point of the materials to be processed in the attritor.

As depicted both asphalt binder 5 (e.g. virgin asphalt) and desired additives 6 are added (either separately or together) into the vessel 1. After processing modified asphalt 7 can be removed from the vessel 1.

Additives that can be used to produce modified asphalt compositions according to the present invention include, but are not limited to polymers, crumb rubber, gilsonite, shale, shingles, and other modifiers. Preferably the additives have solubilities in asphalt of from about 1 to about 99%.

### EXAMPLES

In the following Examples an attritor was used that included a vessel having a heating jacket through which hot oil was circulated in order to keep the products being mixed above their softening points. The grinding media was made of a hard stainless steel balls having three-eighths to one-quarter inch diameters. The mixture to be process in the vessel was added until the vessel it is approximately three-quarters full. The mixing bar inside the vessel had several arms at different levels of the rotating shaft that was centered in the vessel. When the mixing bar was rotated at high rpms of approximately 450 rpm or greater it vortexed the mixture and created shearing and impact forces on the material inside the vessel. Virgin asphalt and additives were added to the attritor either separately or together as a combined slurry. After being processed in the attritor the resulting material was a homogenous mixture of the feed materials, that according to the present invention comprises a modified asphalt binder.

In these Examples asphalt binder compositions were prepared according to the following method. The additives were mixed with virgin asphalt. The attritor vessel, grinding media, and mixing bar were all preheated to approximately 350° F. The mixture to be processed was added to the attritor and a nitrogen blanket is introduced to prevent oxidation during mixing. The mixing bar was rotated at 400-500 rpm. The grinding media and the asphalt additive mixture are vortexed for 7.5-12 minutes. During this process the grinding media provided shearing and impact forces which reduce the asphalt additive particle size. During the size reduction, internal components of the additive are exposed and blended homogenously with the virgin asphalt. The attritor not only mixes more completely, but removes the outer coating on some additive particles exposing a more asphalt compatible section of the asphalt additive.

The quantity of additive(s) added to the virgin asphalt has a very wide range of 2% to 90%, depending on the characteristics of the additive and the desired performance criteria that are required. The optimum range for the additive is between 5% and 28% based on the weight of the asphalt.

The data from the Examples is presented in Table 1 as follows:

TABLE 1

| | | Original | | | | | |
|---|---|---|---|---|---|---|---|
| | Additive | DSR Fail | BBR | E* 10 Hz | E* 1 Hz | | Softening |
| | Method | Temp (° C.) | (° C.) | 30° C. | 30° C. | Separation | Point (° F.) |
| Additive #1 | Dispersion | 74 | −20 | 3851 | 1714 | 1.7 | 129.6 |
| Additive #1 | Attritor | 81 | −19 | 4369 | 2359 | 0.5 | 134.1 |
| Additive #2 | Dispersion | 70 | −21 | 3930 | 2080 | 2.2 | 125.3 |
| Additive #2 | Attritor | 74 | −21 | 4309 | 2068 | 0.4 | 130.6 |
| Additive #3 | Dispersion | 81 | −20 | 4025 | 2060 | −0.4 | 145.0 |
| Additive #3 | Attritor | 80 | −19 | 4408 | 2368 | 0.1 | 143.4 |
| Additive #4 | Dispersion | 72 | −21 | 2854 | 1390 | 0.4 | 129.1 |
| Additive #4 | Attritor | 76 | −19 | 3275 | 1628 | 1 | 136.3 |
| Additive #5 | Dispersion | 75 | −20 | 3470 | 1836 | 10 | 132.1 |
| Additive #5 | Attritor | 77 | −20 | 4294 | 2296 | 4.4 | 136.6 |
| 64 -22 Base Asphalt | N/A | 66 | −23 | 1624 | 425 | N/A | 110 |

The additives used in the Examples and listed in Table 1 above are listed in Table 2 as follows:

| Additive number | Additive |
|---|---|
| Additive #1 | Shale Chinese Blend |
| Additive #2 | Baiguo Shale |
| Additive #3 | Shuiguanyin Shale I |
| Additive #4 | Shuiguanyin Shale II |
| Additive #5 | Huoshi Shale |

In Table 1 the original DSR (Dynamic Shear Rheometer) fail temperature was measured in accordance with AASHTO T315. Separation was measured in accordance with ASTM D-7173. Softening Point was measured in accordance with AASHTO T53 BBR (Bending Beam Rheometer) was measured in accordance with ASTM D 6648. Amplitude Sweep Test (Hz) was measured in accordance with AASHTO TP 62-03 (using the temperatures and frequencies listed).

The “Dispersion” samples were prepared by combining additives with virgin asphalt as a percent of the total sample. When referring to a 5% addition of an additive, 5% of the binder sample is used as the amount of additive to be added to the binder. 100 grams of binder has an additive of 5 grams. The virgin asphalt (PG 64-22) was heated to a range of 165° C. to 175° C. The additive was combined with the asphalt and mixed with a propeller blade for 1 hour. After mixing, the sample was placed in an oven at 163° C. for 1 hour. The sample was removed from the oven and mixed again, with a propeller blade, for 30 minutes. Sampling for each of the tests was done immediately after the 30 minute mixing. Immediate sampling is important to provide homogenous samples.

As can be seen from the data presented in Table 1, the modified asphalt compositions produced by the process method of the present invention have properties and characteristics that distinguish the modified asphalt compositions from modified asphalt compositions that are produced by conventional methods of merely dispersing additives into an asphalt binder.

The modified asphalts binders produced by the present invention are particularly useful for preparing pavements. These pavements may include, but are not limited to, roadway, airport runways, walkways, trails, golf cart paths, pond liner, landfill covers, asphalt underlayment, and bridge decks. Also, the modified asphalt binder compositions of the present invention are advantageous for making other asphalt products besides the pavements. For example, the modified asphalt binder compositions may be useful in roofing applications.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. A method for producing a modified asphalt binder composition which comprises:
providing a stirred ball mill;
adding an asphalt binder into the stirred ball mill, said asphalt binder comprising virgin asphalt;
adding at least one asphalt additive into the stirred ball mill;
adding a mass of grinding media into the stirred ball mill;
mixing then asphalt binder, the least one asphalt additive and grinder media in the stirred ball mill under heating conditions to cause mixing, shearing, impacting and grinding of the mixture; and
recovering a modified asphalt composition that has improved performance characteristics as compared to a similar mixture of asphalt and additive processed in other than a stirred ball mill.

2. A method for producing a modified asphalt binder composition according to claim 1, wherein the stirred ball mill is an attritor.

3. A method for producing a modified asphalt binder composition according to claim 1, wherein the at least on asphalt additive comprises at least one of polymers, crumb rubber, gilsonite, shale, shingles.

4. A method for producing a modified asphalt binder composition according to claim 2, wherein the at least one asphalt additive comprises at least one of polymers, crumb rubber, gilsonite, shale, shingles.

5. A method for producing a modified asphalt binder composition according to claim 2, wherein the attritor comprises a mixing bar that is rotated at from about 400 to about 500 rpm.

6. A method for producing a modified asphalt binder composition according to claim 2, wherein the attritor comprises a mixing bar that is rotated at from at least about 400 rpm.

7. A method for producing a modified asphalt binder composition according to claim 1, wherein the total amount of asphalt additive is about 2 to about 90 wt.% based on the total weight of the asphalt binder and asphalt additive.

8. A method for producing a modified asphalt binder composition according to claim 1, wherein the total amount of asphalt additive is about 5 to about 28 wt.% based on the total weight of the asphalt binder and asphalt additive.

9. A method for producing a modified asphalt binder composition according to claim 2, wherein the total amount of asphalt additive is about 2 to about 90 wt.% based on the total weight of the asphalt binder and asphalt additive.

10. A method for producing a modified asphalt binder composition according to claim 2, wherein the total amount of asphalt additive is about 5 to about 28 wt.% based on the total weight of the asphalt binder and asphalt additive.

11. A modified asphalt binder composition made by the method of claim 1.

12. A modified asphalt binder composition made by the method of claim 1.

13. A paving composition which comprises the modified asphalt binder composition of claim 1 and aggregate material.

14. A paving composition which comprises the modified asphalt binder composition of claim 2 and aggregate material.
